(19) United States
(12) Patent Application Publication
(10) Pub. No.: US 2011/0020556 A1
(43) Pub. Date: Jan. 27, 2011

(54) AQUEOUS COATING COMPOSITION COMPRISING POLYURETHANES AND VINYL POLYMERS

(76) Inventors: Rajasingham Satgurunathan, Waalwijk (NL); Marc Roelands, Waalwijk (NL); Jurgen Scheerder, Waalwijk (NL); Alexander Wilhelmus Martinus Cornelis Donders, Waalwijk (NL)

Correspondence Address: NIXON & VANDERHYE, PC, 901 NORTH GLEBE ROAD, 11TH FLOOR, ARLINGTON, VA, 22203, US

(21) Appl. No.: 12/747,373

(22) PCT Filed: Dec. 8, 2008
(86) PCT No.: PCT/EP08/67033

§ 371 Date: Oct. 6, 2010

(30) Foreign Application Priority Data
Dec. 13, 2007 (EP) 07024217.7
Mar. 27, 2008 (EP) 08005727.6

(51) Int. Cl. C09D 175/04; B05D 3/00

(52) U.S. Cl. 427/388.4; 524/507; 427/385.5; 427/393; 427/393.5; 427/391

(57) ABSTRACT

An aqueous coating composition comprising (i) a polyurethane obtained by the reaction of (a) an isocyanate-terminated pre-polymer obtained from the reaction of components comprising at least one polyisocyanate of which at least 50 wt % is at least one aliphatic polyisocyanate; in an NCO/OH ratio in the range of from 1.75 to 1.05; and (b) an active-hydrogen chain-extending compound; and (ii) a vinyl polymer having a Tg below ambient temperature.

The present invention relates to aqueous coating compositions comprising at least two different polymers with certain film-forming properties, processes for manufacturing such compositions and coatings derived therefrom.

It is known in the art to employ aqueous polymer dispersions of vinyl polymers or, alternatively, of polyurethanes as the basis of aqueous compositions for the production of coatings, the vinyl polymer or polyurethane providing the binder material for such coatings.

It is further known to employ vinyl polymers and polyurethanes in combination in aqueous polymer dispersions in order to further upgrade the properties of the resulting coating whereby the presence of each type of polymer (vinyl or urethane) will improve certain properties of the coating in comparison to using the other type of polymer on its own.

U.S. Pat. No. 5,817,735 describes a primer composition comprising a polyurethane and a polyacrylate wherein the urethane component has a glass transition temperature (Tg) in the range 20 to 50° C. and the acrylate component has a Tg in the range 10 to 90° C. U.S. Pat. No. 6,384,131 discloses compositions containing polyurethane dispersions and water reducible resins such as polyacrylates for use in low VOC basecoat/clearcoat coatings, the aim being to achieve low VOC levels.

U.S. Pat. No. 6,437,036 and U.S. Pat. No. 6,342,558 describe thermosetting aqueous primers which comprise a polyurethane polymer, an acrylic polymer and a cross-linking component. The Tg of the polyurethane should be below 0° C. and that of the polyacrylate at least 20° C. higher than the Tg of the polyurethane. The aim is to provide resistance to stone chipping and formulation with very low VOC.

GB 2362387 discloses mixtures of a multiphase polyacrylate, comprised of an acrylate with a Tg>20° C., an acrylate with a Tg<20° C. and a polyurethane to achieve good hardness properties.

WO 05/23947 discloses an aqueous composition comprising a polyurethane and a polymer dispersion with an minimum film forming temperature above ambient.

U.S. Pat. No. 5,547,710 discloses a polyurethane and a polymeric product having a Tg from 25° C. to 100° C. and epoxy groups and groups reactive to epoxy groups.

U.S. Pat. No. 6,566,438 describes a polyurethane/polymer hybrid with a high film hardness.

U.S. Pat. No. 5,137,961 describes a surfactant-free aqueous polymer dispersion containing an anionic water-dispersible polyurethane and a vinyl polymer in a weight ratio of polyurethane to vinyl polymer of 80:20 to 30:70.

U.S. Pat. No. 6,787,596 discloses a solvent-free polyurethane polymer hybrid dispersion having a high solids content of polymer obtainable by multistage preparation of a polyurethane based dispersion and a subsequent preparation of a hybrid dispersion.

EP 0666275 discloses a method for making polyurethane/acrylic polymer dispersion for film laminate adhesives, being preferably made in the absence of an organic solvent.

WO 99/16805 describes an aqueous polymer dispersion containing a water-dispersed polyurethane and a vinyl (preferably acrylic) polymer in a weight ratio of from 30/70 to 5/95.

The problem with the prior art compositions is that they do not combine toughness and flexibility in the resultant coatings, as these two properties would normally be expected to work against each other.

Traditionally a gain in hardness in a film is offset by a reduction in the elastic properties of the film. Surprisingly, we have now discovered that a certain combination of a polyurethane and a vinyl polymer in an aqueous composition may result in exceptionally good properties, such as a very advantageous balance between 1) toughness, such as impact resistance; and 2) flexibility, such as elongation at break and elasticity; as well as 3) providing tack-free coatings; which balance is maintained in particular when the composition is pigmented. Designing such coatings is a difficult task, as normally the three above mentioned properties would be expected to work against each other, for example tough coatings generally have very little elasticity.

A particular issue arises when pigment is added to a clear coating composition. In this case, usually the hardness of the coating is improved, but the elasticity of the coating will generally decrease, thus making the coating unsuitable for flexible substrates.

The properties of the coating obtained from the composition of the invention rely on the choice of the specific type of polyurethane having a low isocyanate group (NCO)/isocyanate-reactive group (for example OH) ratio and on the amount of the polyurethane in the whole aqueous composition, as well as the combination with a soft (low Tg) vinyl polymer, where the polyurethane to vinyl polymer ratio is such that the polyurethane is in an excess amount compared to the amount of the vinyl polymer. A coating composition designed using the specific parameters mentioned above has an excellent elongation at break, whether it is used as a pigmented coating or just a clear coating comprising no pigment; a very good hardness and impact resistance and provides a good reduction in tack of resultant films and preferably provides tack-free films.

According to the present invention there is provided an aqueous coating composition comprising:

(i) 50 to 95 wt % of a polyurethane obtained by the reaction of:
(a) an isocyanate-terminated pre-polymer obtained from the reaction of components comprising:
   (1) 10 to 40 wt % of at least one polyisocyanate of which at least 50 wt % is at least one aliphatic polyisocyanate;
   (2) 0 to 10 wt % of at least one isocyanate-reactive compound with a weight average molecular weight in the range of from 50 to 500 g/mol, containing ionic or potentially ionic water-dispersing groups;
   (3) 50 to 89 wt % of at least one isocyanate-reactive compound with a weight average molecular weight in the range of from 501 to 5000 g/mol;
   (4) 0 to 10 wt % of at least one isocyanate-reactive compound with a weight average molecular weight in the range of from 50 to 500 g/mol not comprised by (2);
   in an NCO/OH ratio in the range of from 1.75 to 1.05; and
   where (1), (2), (3) and (4) add up to 100%; and
(b) an active-hydrogen chain-extending compound; and

(ii) 5 to 50 wt % of a vinyl polymer having a Tg below ambient temperature;
wherein (i) and (ii) add up to 100%; and

(iii) a liquid medium comprising ≦10 wt % of organic solvent.

For the purposes of the invention, an “aqueous dispersion” of a polymer, or an “aqueous composition” comprising it, means a dispersion or composition of the polymer in a liquid medium of which water is the main or only component. Such a dispersion will typically comprise colloidally dispersed polymer particles, i.e. will typically be in the form of an aqueous polymer latex.

For the purposes of the invention, ambient temperature is defined as 25+/−3° C., more preferably 25° C.

It is evident from all the foregoing that the term “polyurethane” as used in this specification can mean one or more than one polyurethane, and is intended to apply not only to polymers (or pre-polymers) having only urethane linkages formed from isocyanate and hydroxyl groups, but also to polymers, pre-polymers or polymer segments having, in addition to urethane linkages, linkages formed from isocyanate groups and groups such as primary or secondary amines (urea linkages) or thiols. A urethane group is defined as —O—C(═O)—NH— and a urea group is defined as —HN—C(═O)—NH—. The term NCO/OH as used herein is the ratio of isocyanate groups (—NCO) to isocyanate-reactive groups (such as —OH, —NH₂, —NH—, —SH—).

The urethane group/urea group (i.e. urethane/urea) ratio in the polyurethane is preferably >1, more preferably ≧1.3, even more preferably ≧1.75 and most preferably ≧2. Having the urethane/urea group ratio>1 is advantageous as it will contribute to obtaining the desired properties of coatings having a composition according to the invention.

Preferably the polyurethane has a weight average molecular weight of at least 50,000 g/mol as measured by Gel Permeation Chromatography (GPC), using THF (tetrahydrofurane) or HFIP (hexafluoroisopropanol) as solvent (depending which is a better solvent for the specific polyurethane) and polystyrene as standard.

Preferably the polyurethane has a weight average particle diameter (Dw) (i.e. the particle size, since the particles are essentially spherical) less than 200 nm, more preferably within the range of from 20 to 150 nm and most preferably 30 to 100 nm.

The isocyanate-terminated pre-polymer preferably comprises 15 to 35 wt % of at least one polyisocyanate (a)(1). The polyisocyanate (a)(1) used for making the isocyanate-terminated pre-polymer preferably comprises at least 70 wt %, more preferably at least 90 wt %, most preferably at least 95 wt % and especially 100 wt % of an aliphatic (which term includes cycloaliphatic) polyisocyanate and is preferably a diisocyanate. The term aliphatic polyisocyanate (for the sake of clarity) is intended to mean compounds in which all of the isocyanate groups are directly bonded to aliphatic or cycloaliphatic groups, irrespective of whether aromatic groups are also present. The term aromatic polyisocyanate (for the sake of clarity) is intended to mean compounds in which all the isocyanate groups are directly bonded to an aromatic group, irrespective of whether aliphatic groups are also present.

Examples of suitable aliphatic polyisocyanates include ethylene diisocyanate, 1,6-hexamethylene diisocyanate, isophorone diisocyanate, cyclohexane-1,4-diisocyanate, 4,4′-dicyclohexylmethane diisocyanate, cyclopentylene diisoyanate, p-tetra-methylxylene diisocyanate (p-TMXDI) and its meta isomer (m-TMXDI), hydrogenated 2,4-toluene diisocyanate, hydrogenated 2,6-toluene diisocyanate and 1-isocyanato-1-methyl-3(4)-isocyanatomethyl-cyclohexane (IMCI). Aliphatic polyisocyanates improve hydrolytic stability, resist UV degradation and do not yellow.

Preferred aliphatic polyisocyanates are selected from the group consisting of isophorone diisocyanate, 4,4′-dicyclohexylmethane diisocyanate, 1,6-hexamethylene diisocyanate and mixtures thereof.

Mixtures of polyisocyanates can be used and also polyisocyanates which have been modified by the introduction or urethane, allophanate, urea, biuret, carbodiimide, uretonimine or isocyanurate residues.

Examples of suitable aromatic polyisocyanates include but are not limited to p-xylylene diisocyanate, 1,4-phenylene diisocyanate, 2,4-toluene diisocyanate, 2,6-toluene diisocyanate, 4,4′-methylene bis(phenyl isocyanate), polymethylene polyphenyl polyisocyanates, 2,4′-methylene bis(phenyl isocyanate) and 1,5-naphthylene diisocyanate. Aromatic isocyanates, if used at all, include 2,4′-methylene bis(phenyl isocyanate) and 4,4′-methylene bis(phenyl isocyanate). Aromatic polyisocyanates tend to provide chemical resistance and toughness but may yellow on exposure to UV light.

It will be appreciated that the isocyanate-reactive compounds (a)(2) to (a)(4) include polyols and isocyanate-reactive compounds which are other than a polyol (e.g. a diamine, thiol or an aminoalcohol); however, the isocyanate-reactive compounds will preferably be entirely or substantially comprised of a polyol reactant.

The polyurethane preferably has internal water-dispersing groups built into its structure (preferably in pendant and/or terminal positions) during its synthesis (usually as part of the pre-polymer) whereby such groups preferably render the polyurethane self-water-dispersible. Such internal water-dispersing groups may form part of the isocyanate-reactive components (a)(2), (a)(3) and/or the polyisocyanate (a)(1), and/or less preferably may form part of the active-hydrogen chain-extending compound (b).

The isocyanate-terminated pre-polymer is preferably obtained from 1 to 10 wt % and more preferably 3 to 8 wt % of isocyanate-reactive compound (a)(2).

Thus, although the polyurethane may in principle be dispersible in water to form a stabilised dispersion therein solely as a result of the use of an external surfactant (if the polyurethane has no internal dispersing groups) or by high shear mixing, it is far more preferably dispersible as a result of the presence of internal dispersing groups, optionally, or if necessary, in conjunction with an external surfactant. Such internal water-dispersing groups are more usually chain pendant groups and may be of the ionic type (preferably anionic) or of the nonionic type, or a combination of ionic and nonionic types.

Anionic water-dispersing groups comprise for example —SO₃⁻, —OSO₃⁻, —PO₃⁻, and in particular a carboxylate salt group —CO₂⁻.

The conversion of any potentially anionic water-dispersing groups present in the pre-polymer to anionic salt groups may be effected by neutralising the acid groups before, after or simultaneously with the formation of an aqueous dispersion of the pre-polymer. Where acid groups are present additionally or only in the final polyurethane by virtue of being incorporated additionally or only during the chain-extension step the conversion of such groups to anionic salt groups may be effected by neutralising these acid groups during or after the formation of the final polyurethane dispersion.

It is most preferred that dispersing groups are incorporated into the pre-polymer (and/or less preferably by being part of the chain-extender component) via un-ionised carboxylic-acid groups which are subsequently neutralised to carboxylate ion groups using agents such as a tertiary amine, examples of which include triethylamine (TEA), triethanolamine, dimethylaminoethyl methacrylate, dialkylalkanolamines such as dimethylethanolamine, dimethylisopropanolamine (DMIPA) and the like or N-methylmorpholine, N-ethylmorpholine, N-ethylpiperidine, N-methylpiperidine, dimethylbenzyllamine, dimethylcyclohexylamine or an alkaline hydroxide such as K, Na or Li hydroxide or a quaternary ammonium hydroxide. Ammonia itself may also be used. A combination of such agents may be used, either simultaneously or different agents in different steps. An example would be the addition of TEA to the prepolymer and the use of DMIPA in the aqueous phase. Examples of reactants for effecting such incorporation include carboxyl group-bearing diols and triols, and in particular dihydroxy alkanoic acids. The most preferred carboxyl-bearing polyol is 2,2-dimethylol propionic acid (DMPA). Another preferred one is 2,2-dimethylol-n-butyric acid (DMBA). A mixture of DMPA and DMBA may also be used.

The isocyanate-terminated pre-polymer is preferably obtained from 55 to 80 wt % of isocyanate-reactive compound (a)(3).

Isocyanate-reactive compound (a)(3) is preferably a polymeric diol, but may include a polyol of functionality≧2. The polymeric polyol preferably has a weight average molecular weight (hereinafter Mw) within the range of from 501 to 4,000 g/mol, more preferably from 700 to 3,000 g/mol. Such polyol in principle may be selected from any of the chemical classes of polyols used or proposed to be used in polyurethane synthesis. In particular the polyol may be a polyester polyol, a polyesteramide polyol, a polyether polyol, a polythioether polyol, a polycarbonate polyol, a polyacetal polyol, a polyvinyl polyol and/or a polysiloxane polyol. More preferably the polyol is selected from a polyester polyol, a polycarbonate polyol, a polyether polyol and/or a polysiloxane polyol, and particularly preferably is selected from a polyether polyol and/or a polyester polyol.

Polyester polyols which may be used include hydroxyl-terminated reaction products of polyhydric alcohols. Polyesters obtained by the polymerisation of lactones or which have incorporated carboxy groups may also be used. Polyesteramides may be obtained by the inclusion of amino-alcohols such as ethanolamine in polyesterification mixtures.

Polyether polyols which may be used include products obtained by the polymerisation of a cyclic oxide or by the addition of one or more such oxides to polyfunctional initiators. Especially useful polyether polyols include polyoxypropylene diols and triols, poly (oxyethylene-oxypropylene) diols and triols and polytetramethylene ether glycols.

Isocyanate-reactive compound (a)(3) may also comprise nonionic water-dispersing groups. Nonionic water-dispersing groups are typically pendant polyoxyalkylene groups, particularly polyethylene oxide (PEO) groups. Such groups may, for example be provided by employing diols having pendant PEO chains as a reactant either in the pre-polymer formation and/or (less preferably) as part of the chain-extender component.

If desired, the PEO chains may contain units of other alkylene oxides in addition to the ethylene oxide units. Thus, PEO chains in which up to 60% of the alkylene oxide units are propylene oxide units, the remainder being ethylene oxide units, may be used.

The isocyanate-terminated pre-polymer is preferably obtained from 1 to 10 wt % and more preferably 2 to 7 wt % of isocyanate-reactive compound (a)(4).

Isocyanate-reactive compound (a)(4) is preferably a diol. The diol preferably has a Mw within the range of from 50 to 450 g/mol, more preferably from 70 to 200 g/mol.

Examples of compound (a)(4) include ethyleneglycol, neopentyl glycol, 1-propanol, butanediol, 1,4-cyclohexyldimethanol, 1,4-bishydroxymethylcyclohexane, 1,3-bis(4-hydroxycyclohexyl)propane and perhydrogenated bisphenol A and the like.

The isocyanate-reactive compound (a)(3) and (a)(4) may also include one or more organic monools.

The active-hydrogen containing chain-extending compound which may be reacted with the pre-polymer component is preferably an amino-alcohol, a primary or secondary aliphatic, alicyclic, aromatic, araliphatic or heterocyclic diamine or polyamine (i.e. having 3 or more amine groups), or hydrazine or a substituted hydrazine, or a polyhydrazide (preferably a dihydrazide).

Water-miscible chain-extenders are preferred.

Water itself may be used as an indirect chain-extender because it will slowly convert some of the terminal isocyanate groups of the pre-polymer to amino groups (via unstable carbamic acid groups) and the modified pre-polymer molecules will then undergo chain-extension. The above mentioned active-hydrogen chain-extenders (which can be called direct chain-extender compounds) will provide the predominant chain-extension reaction if used.

Examples of such direct chain-extenders useful herein include ethylene diamine, diethylene triamine, triethylene tetramine, propylene diamine, butylene diamine, hexamethylene diamine, cyclohexylene diamine, piperazine, 2-methyl piperazine, phenylene diamine, toluoylene diamine, xylylene diamine, tri(2-aminoethyl) amine, 3,3-dinitrobenzidine, 4,4′-diaminodiphenylmethane, methane diamine, m-xylene diamine, isophorone diamine and adducts of diethylene triamine with acrylate or its hydrolysed products. Also materials such as hydrazine (e.g. in the form of its mono-hydrate), azines such as acetone azine, substituted hydrazines such as, for example, dimethyl hydrazine, 1,6-hexamethylene-bis-hydrazine, carbodihydrazine, dihydrazides of dicarboxylic acids and sulphonic acids such as adipic acid dihydrazide, oxalic acid dihydrazide, isophthalic acid dihydrazide, hydrazides made by reacting lactones with hydrazine such as gamma-hydroxylbutyric hydrazide, bis-semi-carbazide, and bis-hydrazide carbonic esters of glycols. Another suitable class of chain-extenders is the so-called “Jeffamine” compounds with a functionality of 2 or 3 (available from Huntsman). These are polypropylene oxide (PPO) or PEO-based di or triamines, e.g. “Jeffamine” T403 and “Jeffamine” D-400.

Preferably the active-hydrogen chain-extender compound is or includes hydrazine (usually in the form of its monohydrate), or a di- or triamine (usually a diamine) of molecular weight below 300 g/mol.

When the chain-extender is an direct compound (not water), for example a polyamine or diamine or hydrazine, it may for example be added to the aqueous dispersion of pre-polymer for example using in-line mixing, or it may for example already be present in the aqueous medium when the pre-polymer is dispersed therein, or it may for example simply be fed with the pre-polymer to water.

The total amount of chain-extender compound (isocyanate-reactive groups) employed (other than water) is preferably such that the ratio of active-hydrogens in the chain-extender to isocyanate (NCO) groups in the pre-polymer component is preferably within the range of from 0.4 to 2.0 more preferably 0.6 to 1. Of course, when only water is employed as an indirect chain-extender, these ratios will not be applicable since the water, functioning both as an indirect chain-extender and a dispersing medium, will be present in a gross excess relative to the residual NCO groups.

The isocyanate-terminated pre-polymer may be prepared in conventional manner by reacting a stoichiometric excess of the polyisocyanate with the isocyanate-reactive compounds (and any other reactants) under substantially anhydrous conditions at a temperature between about 30° C. and about 130° C. until reaction between the isocyanate groups and the isocyanate-reactive (usually all hydroxyl) groups is substantially complete. During the production of the isocyanate-terminated pre-polymer the reactants are preferably used in proportions corresponding to a ratio of isocyanate groups to isocyanate-reactive (preferably all hydroxyl) groups (NCO/OH) from about 1.7 to 1.1, more preferably from 1.6 to 1.1. and most preferably from 1.5 to 1.3.

This preferred ratio contributes to the balance of properties of the coatings resulting from the compositions of the invention.

If desired, catalysts such as dibutyltin dilaurate or stannous octoate may be used to assist pre-polymer formation although optionally no catalyst may be used during the pre-polymer formation.

A diluent, such as an organic solvent or a reactive component, may optionally be added before, during or after pre-polymer formation to control the viscosity provided it does not vitiate the obtaining of a solvent-free final dispersion (such solvent may thus subsequently need to be removed as far as is possible). Suitable organic solvents which may be used include acetone, methylethylketone, dimethylformamide, diglyme, N-methylpyrrolidone, N-ethylpyrrolidone, ethyl acetate, ethylene and propylene glycol diacetates, alkyl ethers of ethylene and propylene glycol diacetates, alkyl ethers of ethylene and propylene glycol monoacetates, toluene, xylene and sterically hindered alcohols such as t-butanol and diacetone alcohol. The preferred solvents are water-miscible solvents such as N-methylpyrrolidone, acetone and dialkyl ethers of glycol acetates or mixtures of N-methylpyrrolidone and methyl ethyl ketone.

Preferably the aqueous coating composition comprises≧55 wt %, more preferably ≧60 wt % of polyurethane (i) obtained by the reaction of components (a) and (b). Preferably the aqueous coating composition comprises≦90 wt %, more preferably ≦85 wt % of polyurethane (i) obtained by the reaction of components (a) and (b).

Preferably the aqueous coating composition comprises≧10 wt %, more preferably ≧15 wt % of vinyl polymer (ii) having Tg below the ambient temperature. Preferably the aqueous coating composition comprises≦50 wt %, more preferably ≦40 wt %, even more preferably ≦30 wt % of vinyl polymer (ii) having Tg below the ambient temperature.

In cases where the vinyl polymer is formed in situ with the polyurethane, the solvent for use in the pre-polymer (if having suitable solvent characteristics) may be or may comprise (e.g. optionally in conjunction with organic solvents of the type described above) a monomer or monomer mixture which is subsequently polymerised to form the vinyl polymer. Preferably the vinyl polymer is formed in situ.

The polyurethane is preferably prepared as an aqueous dispersion by dispersing the isocyanate-terminated polyurethane pre-polymer (optionally carried in an organic solvent medium which may include or consist of a monomer for the vinyl polymer, also known as a reactive diluent) in an aqueous medium, preferably utilising self-dispersibility properties of the pre-polymer arising from internal dispersing groups in the isocyanate-terminated pre-polymer, although free surfactant may additionally be employed if desired, and chain-extending the pre-polymer with an active-hydrogen compound in the aqueous phase, the chain-extender being present in the aqueous phase during dispersion or added subsequently (i.e. chain-extension can take place during and/or after the dispersion into water in this embodiment).

In an alternative embodiment, the pre-polymer for the polyurethane may be dispersed in an aqueous medium in which a preformed vinyl polymer is already present, followed by chain-extension as described above. In a further alternative embodiment, known as mass dispersion, the pre-polymer may be dispersed in an aqueous medium in which are already dispersed the monomer components for the vinyl polymer, followed by chain-extension as described above. The monomer components for the vinyl polymer are then polymerised as described below.

The pre-polymer may be dispersed in water using techniques well known in the art. Preferably, the pre-polymer is added to the water with agitation or, alternatively, water may be stirred into the pre-polymer component.

The chain-extension can be conducted at elevated, reduced or ambient temperatures. Convenient temperatures are from about 5° C. to 90° C., more preferably from 10° C. to 60° C.

As is well known, the glass transition temperature (Tg) of a polymer is the temperature at which it changes from a glassy brittle state to a plastic, rubbery state. The glass transition temperatures of the polymers in the examples were calculated by means of the Fox equation. Thus the Tg, in degrees Kelvin, of a copolymer having “n” copolymerised comonomers is given by the weight fractions W of each comonomer type and the Tg values of the homopolymers (in Kelvin) derived from each comonomer according to the equation: 1/Tg=W₁/Tg₁+W₂/Tg₂+ . . . +Wₙ/Tgₙ. The calculated Tg in Kelvin may be readily converted to ° C.

In a preferred embodiment, the vinyl polymer has a Tg of ≦20° C., more preferably ≦15° C., most preferably ≦10° C. and especially≦5° C.

In another aspect of the invention, the vinyl polymer is a multiphase polymer, by which it is meant that it comprises for example at least one soft phase (Tg<25° C., more preferably ≦20° C.) and a hard phase (Tg≧25° C.) or the vinyl polymer is prepared by a technique known as power feed (described in U.S. Pat. No. 3,804,881) resulting in gradient particle morphologies, as long as the overall Tg of the vinyl polymer (based on the comonomers in all the phases together) as calculated by the Fox equation is below ambient temperature.

The vinyl polymer may also be an oligomer-supported polymer, by which is meant that a low weight average molecular weight Mw vinyl oligomer (typically 5,000 to 50,000 Daltons) is first prepared as a stabilising agent for a second phase where a vinyl polymer is prepared in the presence of the vinyl oligomer and polyurethane. In this case the polymer is the vinyl polymer and should preferably have a Tg below ambient and the Tg of the oligomer can vary but preferably the overall Tg of the oligomer and polymer together is below ambient temperature.

Preferably the vinyl polymer has a weight average molecular weight (Mw) of at least 200,000 g/mol, more preferably ≧250,000 g/mol and most preferably ≧500,000 g/mol.

The particle size of the vinyl polymer is preferably between 20 to 800 nm, more preferably between 25 to 600 nm and most preferably between 30 to 400 nm.

By a vinyl polymer herein is meant a homo- or copolymer derived from the addition polymerisation (using a free radical initiated process and usually in an aqueous medium), preferably by aqueous emulsion polymerisation, of a monomer composition comprising one or more monomers of the formula: CH₂═CR¹R² where R¹ and R² are each independently selected from the group comprising H, optionally substituted alkyl of 1 to 20 carbon atoms (more preferably 1 to 8 carbon atoms), optionally substituted cycloalkyl of 5 to 20 carbon atoms, optionally substituted acyl and others. Such olefinically unsaturated monomers are referred to herein as vinyl monomers. Examples of such monomers include 1,3-butadiene, isoprene, styrene, α-methyl styrene, divinyl benzene, acrylonitrile, methacrylonitrile, vinyl halides such as vinyl chloride, vinyl esters such as vinyl acetate, vinyl propionate, vinyl laurate, and vinyl esters of versatic acid such as VeoVa™ 9 and VeoVa™ 10 (VeoVa is a trademark of Shell), heterocyclic vinyl compounds, alkyl esters of mono-olefinically unsaturated dicarboxylic acids (such as di-n-butyl maleate and di-n-butyl fumarate, and olefinically unsaturated monocarboxylic or dicarboxylic acids, such as acrylic acid, methacrylic acid, 2-carboxyethyl acrylate, fumaric acid, maleic acid, and itaconic acid, and optionally substituted alkyl esters of 1 to 20 carbon atoms thereof.

In a preferred embodiment of the present invention, the vinyl polymer comprises an acrylic polymer. By an acrylic polymer herein is meant a homo- or copolymer derived from the addition polymerisation of a monomer composition comprising at least 40 wt % of one or more monomers of the formula: CH₂═CR³COOR⁴ where R³ is H or methyl, and R⁴ is H, optionally substituted alkyl of 1 to 20 carbon atoms (more preferably 1 to 8 carbon atoms) or cycloalkyl of 5 to 20 carbon atoms. Such monomers are referred to herein as acrylic monomers. More preferably, the monomer composition contains at least 50 wt % of acrylic monomer, and particularly at least 60 wt %. Examples of such acrylic monomers include methyl (meth)acrylate, ethyl (meth)acrylate, n-butyl (meth)acrylate, 2-ethylhexyl (meth)acrylate, isopropyl (meth)acrylate, n-propyl (meth)acrylate, and hydroxyalkyl (meth)acrylates such as hydroxyethyl (meth)acrylate and 2-hydroxypropyl (meth)acrylate. Preferred acrylic monomers include methyl (meth)acrylate, ethyl (meth)acrylate, n-butyl (meth)acrylate and 2-ethylhexyl (meth)acrylate.

When the vinyl polymer comprises an acrylic polymer, the monomer composition to form the acrylic polymer may include monomers, optionally vinyl, other than the acrylic monomers defined above and which are copolymerised with one or more of such acrylic monomers.

Preferably the vinyl polymer comprises≦8 wt %, more preferably ≦5 wt %, most preferably ≦2 wt %, especially≦0.5 wt % and most especially 0 wt % of monomers containing ionic or potentially ionic water-dispersing groups. This may provide extra colloidal stability.

The vinyl polymer may often advantageously contain comonomers which provide an adhesion and/or crosslinking functionality to the resulting polymer coating. Examples of these, some of which have already been mentioned above, include acrylic and methacrylic monomers having at least one free carbonyl, carboxyl, hydroxyl, epoxy, aceto acetoxy, or amino group, such as acrylic acid and methacrylic acid (and also their amides, hydroxyalkyl esters and amino alkyl esters), glycidyl acrylate, glycidyl methacrylate, diacetone acrylamide, aceto acetoxy ethyl methacrylate, t-butylamino ethyl methacrylate and dimethylamino ethyl methacrylate; other adhesion promoting monomers include heterocyclic vinyl compounds such as vinyl pyrrolidone, vinyl imidazole, phenoxy ethyl (meth)acrylate and tetrahydrofuryl (meth)acrylate and cyclic ureido compounds. The vinyl polymer could also include monomers which impart in situ crosslinking (or “precrosslinking”) in the polymer, i.e. crosslinking in the polymer as it is being formed (rather than subsequently after a coating has been formed as do the crosslinking monomers mentioned above); examples of such monomers include allyl methacrylate, tetraethylene glycol methacrylate, and divinyl benzene.

Such monomers (described in the preceding paragraph) when used are normally used in an amount of from 0.05 to 15 wt %, more usually from 0.5 to 10 wt % or 1 to 6 wt % of the total weight of monomers used for polymerisation.

As discussed above, in an alternate embodiment of the invention, amino functionality can be incorporated into a multistage polymer by preparing a polymer comprising monomer units of an olefinically unsaturated acid, such as acrylic acid or methacrylic acid and subsequently converting at least a proportion of the carboxylic acid groups to amino groups (as part of amino ester groups) by an imination reaction using an alkylene imine such as ethylene imine or propylene imine.

The solids content of the vinyl polymer if pre-formed is preferably between 20 to 70 wt %, more preferably 30 to 60 wt % and most preferably 35 to 55 wt %.

As described above the polyurethane and the vinyl polymer may be combined in the form of a blend, for example by post adding a pre-formed vinyl polymer after preparation of the polyurethane. Alternatively the vinyl polymer may be prepared in the presence of the polyurethane (in situ preparation). The resultant combination if the vinyl polymer has been prepared in the presence of a polyurethane during and/or after the latter's formation is known as a hybrid. The use of hybrids allows for the further tailoring of properties of the coatings resulting from the compositions of the invention.

If formed in situ, the vinyl polymer is made by an aqueous free-radical polymerisation process and such polymerisation may be performed simultaneously with the chain-extension step of the polyurethane, or performed subsequent to the chain-extension step, or performed partly simultaneously with the chain-extension step and partly subsequent to the chain-extension step.

All of the monomer to be polymerised in a hybrid may be present at the commencement of the polymerisation, or in cases where all or part of the monomer to be polymerised has been introduced subsequent to the formation of an aqueous pre-polymer dispersion, some or all of that monomer may be added to the reaction medium during the course of the polymerisation (in one or more stages or continuously). Alternatively some or all of the monomer can be converted to polymer and be present in the aqueous phase before dispersion of the urethane pre-polymer in the aqueous phase.

When making a hybrid, the monomer for making the in situ prepared polymer may be introduced in the process at any suitable stage. For example, when the aqueous dispersion of the urethane pre-polymer is formed in the process to make the polyurethane all of the monomer for the vinyl polymer may be added to the pre-polymer prior to its dispersion into water, or all of the monomer may be added subsequent to dispersion (or may have already been added to the water prior to the dispersion of the pre-polymer therein), or part of the monomer may be added to the pre-polymer prior to dispersion and the remainder added subsequent to dispersion. In the case where all or part of the monomer is added to the pre-polymer prior to dispersion into water, such monomer could be added to the pre-polymer subsequent to its formation or prior to its formation, or some could be added subsequent to its formation and some added prior to its formation. In the case where any monomer is added prior to the pre-polymer formation it may (as mentioned above) provide at least part of a solvent system for the reaction to form the pre-polymer (if it possesses suitable solvent characteristics). Particular examples of such processes are detailed in U.S. Pat. No. 5,137,961 and U.S. Pat. No. 4,664,430.

The polymerisation of the monomer composition to form the vinyl polymer will normally require the use of a free-radical-yielding initiator to initiate the polymerisation. Suitable free-radical-yielding initiators include inorganic peroxides such as K, Na or ammonium persulphate, hydrogen peroxide, or percarbonates; organic peroxides, such as acyl peroxides including for example benzoyl peroxide, alkyl hydroperoxides such as t-butyl hydroperoxide (t-BHPO) and cumene hydroperoxide; dialkyl peroxides such as di-t-butyl peroxide; peroxy esters such as t-butyl perbenzoate and the like; mixtures may also be used. The peroxy compounds are in some cases advantageously used in combination with suitable reducing agents (redox systems) such as Na or K pyrosulphite or bisulphite, and i-ascorbic acid. Azo compounds such as azoisobutyronitrile may also be used. Metal compounds such as Fe.EDTA (EDTA is ethylene diamine tetracetic acid) may also be usefully employed as part of a redox initiator system. An initiator system partitioning between the aqueous and organic phases, for example a combination of t-butyl hydroperoxide, iso-ascorbic acid and Fe.EDTA, may be of particular use. The amount of initiator or initiator system to use is conventional, for example within the range 0.05 to 6 wt % based on the total monomer used.

Molecular weight control of the vinyl polymer may be provided by catalytic chain-transfer agents, or may be provided by using chain-transfer agents such as mercaptans and halogenated hydrocarbons, for example mercaptans such as n-dodecylmercaptan, n-octylmercaptan, t-dodecylmercaptan, mercaptoethanol, iso-octyl thioglycolate, C₂ to C₈ mercapto carboxylic acids and esters thereof such as 3-mercaptopropionic acid and 2-mercaptopropionic acid; and halogenated hydrocarbons such as carbon tetrabromide and bromo trichloromethane. In catalytic chain-transfer polymerisation (CCTP) a free-radical polymerisation is carried out using a catalytic amount of a selected transition metal complex acting as a catalytic chain-transfer agent (CCTA), and in particular a selected cobalt chelate complex.

Combinations of conventional chain-transfer agents and catalytic chain-transfer agents may also be used.

An aqueous polymerisation to pre-form the vinyl polymer normally needs to be performed in the presence of a stabilising and/or dispersing material (such as oligomers used to prepare oligomer-supported polymers as described in WO 95/29963) and when making an aqueous latex of a vinyl polymer, a conventional emulsifying agent would need to be employed (e.g. anionic and/or nonionic emulsifiers such as Na salts of dialkylsulphosuccinates, Na salts of sulphated oils, Na salts of alkyl sulphonic acids, Na, K and ammonium alkyl sulphates such as sodium lauryl sulphate, C₂₂₋₂₄ fatty alcohols, ethoxylated fatty acids and/or fatty amides, and Na salts of fatty acids such as Na stearate and Na oleate; the amount used is usually 0.1 to 5% by weight on the weight based on the total vinyl monomer used). When using an in situ process however to form the vinyl polymer, a polyurethane polymer containing internal dispersing groups usually removes the requirement for the use of a separately added conventional emulsifying agent since the polyurethane itself acts as an effective dispersant for the polymerisation, although a conventional emulsifier can be still employed if desired.

In an embodiment of the present invention there is provided a process for the manufacture of an aqueous coating composition as herein described which comprises the following steps:

(I) (i) reaction of components (a)(1) to (a)(4) together to form an isocyanate-terminated pre-polymer;
(ii) dispersion of the isocyanate-terminated pre-polymer in water;
(iii) chain-extension of the isocyanate-terminated pre-polymer by reaction with an active-hydrogen chain-extending compound to form the polyurethane; and

(II) admixture of at least a preformed vinyl polymer having a Tg below ambient temperature.

In a further embodiment of the invention there is provided a process for the manufacture of an aqueous coating composition as herein described which comprises the following steps:

(I) (i) reaction of components (a)(1) to (a)(4) to form an isocyanate-terminated pre-polymer;
(ii) dispersion of the isocyanate-terminated pre-polymer in water;
(iii) chain-extension of the isocyanate-terminated pre-polymer by reaction with an active-hydrogen chain-extending compound to form the polyurethane;

(II) admixture of monomer followed by reaction under conditions sufficient to effect emulsion polymerisation to form a vinyl polymer having a Tg below ambient temperature.

In both the above process embodiments, it will be understood to those skilled in the art that the preferred order within step (I) is (i), (ii) and then (iii), however step (II) may also take place within step (I) after step (i) has been performed, i.e. the monomers of step (II) can be added to the isocyanate terminated pre-polymer before performing step (ii) or (iii).

Any or all of the above described processes for the manufacture of the polyurethane and or vinyl polymer may be carried out by a technique which comprises in-line mixing, as described in Research Disclosure (2002), 457 (May), page 772-774 or by the technique of mass dispersion, as described above.

In the invention composition, it is preferred that the weight average particle diameter (Dw) (i.e. the particle size, since the particles are essentially spherical) of any polyurethane vinyl polymer hybrid particles are within the range of from 20 to 400 nm, more preferably 30 to 150 nm. (It is to be understood that Dw is also applicable to, i.e. is the average of bimodal or polymodal particle size distributions, as well as monomodal distributions). Smaller particle sizes may result in more translucent coatings which is preferred.

There is further provided according to the invention an aqueous coating composition which is substantially solvent-free. By a substantially solvent-free aqueous composition, is meant that the liquid medium of the composition comprises less than 5 wt % of organic solvent, more preferably less than 2 wt % and most preferably no organic solvent at all. It is to be understood that no solvent at all means no added solvent, as for example it may be that some minor amounts of solvents are in the composition as a result from adding additives etc. (In this specification organic plasticisers are intended to be within the scope of the term “solvent”; these, like coalescent solvents, are also used in the art to decrease minimum film forming temperatures although strictly speaking they are not solvents). In a particularly preferred embodiment of the present invention, the composition as herein described is totally solvent (and therefore plasticiser) free. Preferably the polyurethane and the vinyl polymer are made using solvent-free processes.

Preferably the invention composition comprises thermoplastic polyurethane and or vinyl polymers and not thermosetting polymers as thermosetting polymers inherently may have a lower elongation at break. Preferably the polyurethane and the vinyl polymer are thermoplastic polymers.

The solids content of the aqueous composition of the invention is usually within the range of from about 20 to 65 wt % on a total weight basis, more usually 30 to 55 wt %. Solids content can, if desired, be adjusted by adding water or removing water (e.g. by distillation or ultrafiltration).

In a further particular embodiment, there is provided a non-pigmented coating composition as described herein which when coated into a film gives a tack-free film with an elongation at break preferably ≧300% and more preferably ≧390%. Preferably the elongation at break is ≦800% and more preferably ≦600%.

The composition of the current invention may for example be used, appropriately formulated if necessary, for the provision of films, including inter alia polishes, varnishes, lacquers, or paints. The composition of the current invention may also be used for the provision of inks or adhesives. Optional further additives or components (to form compositions) include but are not limited to, defoamers, rheology control agents, thickeners, dispersing and stabilising agents (usually surfactants), wetting agents, fillers, extenders, fungicides, bacteriocides, anti-freeze agents, crosslinking agents, coalescents, waxes and pigments.

Preferably the invention composition, if a crosslinkable composition, is crosslinkable at or below ambient temperature.

In an embodiment there is provided a composition as described herein which further comprises up to 10 wt % of a crosslinker based on the total polymer weight (polyurethane and vinyl polymer). The crosslinker is preferably selected from but not limited to the group comprising the following types: urea-formaldehyde, melamine-formaldehyde, carbodiimide, aziridine, isocyanates, epoxy, silanes and/or mixtures thereof. It is preferred that the crosslinking takes place at or around ambient temperature and does not require excess application of heat e.g. stoving. In another embodiment the polyurethane may be autoxidisable by having unsaturated fatty acids incorporated into the polyurethane.

In a particularly preferred embodiment, the composition as described herein further comprises a pigment and/or an extender. Pigments which may be used in the present invention include, for example, titanium dioxide, iron oxide, chromium-based compounds and metal phthalocyanine compounds. They are finely divided inorganic or organic powders (usually of particle size in the region of 0.1 to 10 μm, obtained for example by grinding or milling) for achieving properties such as colour, opacity and hiding power. They are usually incorporated into a coating composition in the form of a dry powder or a uniform dispersion of the pigment in a suitable carrier medium. Titanium dioxide (a white pigment) is the most preferred pigment in the present invention. Extenders which may be used include calcium carbonate and china clay.

There is further provided a composition as described herein with a pigment volume concentration (PVC) in the range of from 10 to 70%, preferably 10 to 50% and more preferably 15 to 40%, wherein PVC is defined as:

$$\frac{[ volume ( pigment ) + volume ( extender ) ]}{[ volume ( pigment ) + volume ( extender ) + volume ( binder ) ]}$$

wherein “binder” refers to the solid polymer in the composition according to the first embodiment of the present invention.

In a further embodiment of the invention, there is provided a pigmented composition as described herein with a pigment volume concentration PVC of 20+/−2% which when coated into a film gives a tack-free film with an impact resistance of at least 35 N and preferably at least 40 N when measured as described below.

In a further particular embodiment, there is provided a pigmented composition as described herein with a pigment volume concentration (PVC) of 20+/−2% which when coated into a film gives a tack-free film with an elongation at break preferably ≧300%. Preferably the elongation at break is ≦600%, more preferably ≦500% and most preferably ≦480%.

When pigment is added to the clear (non-pigmented) coating composition of the invention, a reduction in elongation at break will be generally observed that can be quantitatively defined as being the ratio between (elongation of the non-pigmented coating minus the elongation of the pigmented coating) and the elongation of the clear coating.

In a preferred embodiment, there is provided a pigmented composition as described herein with a pigment volume concentration PVC of 20+/−2% which when coated into a film gives a tack-free film which has a reduction in elongation at break less than 30%, more preferably less than 25% and most preferably less than 20% when compared with an equivalent non-pigmented film.

In another embodiment of the invention there is provided a composition which, when coated into a pigmented film having a pigment volume concentration PVC of 20+/−2%, gives a tack-free film with a König hardness in the range of from 15 to 35 seconds, an elongation at break>300% and an impact resistance of at least 30 N. Preferably the composition has a reduction in elongation at break less than 30% when compared with an equivalent non-pigmented film.

The composition of the invention may be combined with one or more than one additional binder. Combination may be by blending or an in situ preparation. Combination by blending may be by simple mixing under stirring or bringing the components together by an in-line mixing process.

These additional binders may have a monomodal or bimodal particle size distribution and may be a single phase, multiphase, seeded or oligomer supported polymer, or may be prepared by the power feed process. These additional binders may be self-crosslinking or pre-crosslinked.

These additional binders may be vinyl polymers, alkyd polymers, polyesters, epoxy polymers, fluorine containing polymer or other polyurethane and/or hybrids of any of the preceding polymers such as polyurethane/acrylics and uralkyds. Preferably any additional binders are vinyl polymers.

The amount of the composition of the invention that is combined with additional binders is determined by the balance of properties that is required. A higher amount of the composition of the invention (for example 20% w/w) will result in higher impact resistance, higher toughness and higher level of elongation at break than when lower amounts (for example 5% w/w) are used.

In special embodiment, there is provided a pigmented composition as described herein with a pigment volume concentration PVC of 20+/−2% (used on its own or combined with other binders) which when coated into a film gives a tack-free film with an impact resistance of at least 30 N and has a reduction in elongation at break less than 30%, when compared with an equivalent non-pigmented film.

In a further special embodiment, there is provided a pigmented composition as described herein with a pigment volume concentration PVC of 20+/−2% (used on its own or combined with other binders) which when coated into a film gives a tack-free film of König hardness in the range of from 15 to 35 seconds.

In yet another embodiment, there is provided a pigmented composition as described herein with a pigment volume concentration PVC of 20+/−2% (used on its own or combined with other binders) which when coated into a film gives a tack-free film of König hardness in the range of from 15 to 35 seconds, with an impact resistance of at least 30 N and has a reduction in elongation at break less than 30%, when compared with an equivalent non-pigmented film.

In yet another embodiment, there is provided an aqueous coating composition comprising:

(i) 50 to 95 wt % of a polyurethane obtained by the reaction of:
(a) an isocyanate-terminated pre-polymer obtained from the reaction of components comprising:
   (1) 10 to 40 wt % of at least one polyisocyanate of which at least 50 wt % is at least one aliphatic polyisocyanate;
   (2) 0 to 10 wt % of at least one isocyanate-reactive compound with a weight average molecular weight in the range of from 50 to 500 g/mol, containing ionic or potentially ionic water-dispersing groups;
   (3) 50 to 89 wt % of at least one isocyanate-reactive compound with a weight average molecular weight in the range of from 501 to 5000 g/mol;
   (4) 0 to 10 wt % of at least one isocyanate-reactive compound with a weight average molecular weight in the range of from 50 to 500 g/mol not comprised by (2);
   in an NCO/OH ratio in the range of from 1.75 to 1.05;
   with a urethane/urea ratio>1; and
   where (1), (2), (3) and (4) add up to 100%; and
(b) an active-hydrogen chain-extending compound; and

(ii) 5 to 50 wt % of a vinyl polymer having a Tg below ambient temperature; a weight average molecular weight of at least 200,000 g/mol and comprising ≦8 wt % of monomers containing ionic or potentially ionic groups;
wherein (i) and (ii) add up to 100%; and

(iii) a liquid medium comprising 10 wt % of organic solvent; which composition further comprises pigment with a pigment volume concentration in the range of from 10 to 70%, and;

wherein the aqueous coating composition when comprising a pigment volume concentration PVC of 20±2% and coated into a film has a tack-free film of König hardness in the range of from 15 to 35 seconds; an impact resistance of at least 30 N; and an elongation at break 300%.

There is further provided according to the invention a method of coating a surfaces of a substrate with an aqueous composition as defined above. The compositions once applied may be allowed to dry naturally at ambient temperature, or the drying process may be accelerated by heat. Preferably the substrate comprises architectural surfaces. Preferably such surfaces are porous and more preferably the surfaces are wood. In particular the compositions of the present invention are suitable for providing the basis of protective coatings for wooden substrates (e.g. wooden floors and window frames), plastics, metal and paper.

There is further provided according to the invention a coating obtained from a composition as described above.

There is further provided according to the invention a substrate having a coating obtained as described above.

There is also provided a film obtained from a composition as described above.

The present invention is now further illustrated but in no way limited by reference to the following examples. Unless otherwise specified all parts, percentages, and ratios are on a weight basis.

### Materials Used

DMPA=dimethylol propionic acid
Priplast 3192=dimer fatty acid based polyester polyol available from Uniquema, with a Mw 2000 & OH value of 56
MMA=methyl methacrylate
BA=n-butyl methacrylate
IPDI=isophorone diisocyanate (aliphatic)
lonol CP=butylated hydroxyl toluene
TEA=triethylamine
BDG=butyldiglycol (cosolvent)
Dehydran 1293=a siloxane based defoamer available from Cognis
Borchigel L75=associative thickener, available from Borchers
AMP-90=3-aminopropanol as a 90 wt % solution
Surfynol 104E=wetting agent available from Air Products
NeoCryl BT-24=vinyl polymer dispersion, available from DSM NeoResins BV
Tioxide Kronos 2190=white pigment available from Kronos
NPG=neopentyl glycol

Note: MMA: BA was used in a range of ratios from 0:100 to 100:0 wt % to prepare the vinyl polymers described below.

### EXAMPLE 1

### (E1) Preparation of a Polyurethane Vinyl Hybrid (80/20)

A 2000 cm³ flask equipped with a thermometer and overhead stirrer was charged with DMPA (44.0 g), Priplast 3192 (623.1 g), MMA (73.8 g), BA (146.2 g), IPDI (212.9 g) and lonol CP (0.33 g). The NCO/OH ratio was 1.50.

This mixture was heated to 50° C. and tin octoate (0.16 g) was added. The reaction was allowed to exotherm to 90° C. After the exotherm was complete the reaction was kept at 90° C. for 1 hour and another portion of tin octoate (0.16 g) was added. After that, the reaction temperature was maintained at 90° C. for an additional 1.5 hours.

The NCO-content of the isocyanate-terminated pre-polymer was 2.32% (theoretical 2.44%). After cooling the pre-polymer to 75° C., TEA (29.9 g) was added.

A dispersion of the isocyanate-terminated pre-polymer was made by feeding 950.1 g of the TEA neutralised, isocyanate-terminated pre-polymer over 1 hour to 1615 g of deionised water. The isocyanate-terminated pre-polymer temperature during dispersion was kept at 70° C. and the dispersion temperature was controlled at 25° C. When the pre-polymer feed was completed, a 15.2% hydrazine solution (45.4 g) was added together with water (15.0 g) to effect chain-extension (0.85 SA on residual NCO content). SA has herein the meaning of stoichiometric equivalent.

Fifteen minutes after completion of chain-extension, a 10% aqueous solution of tBHPO (9.26 g) was added together with a 1% aqueous solution of FeEDTA (0.92 g). The radical polymerisation for producing a polyurethane vinyl hybrid dispersion was executed by feeding a 2.5% aqueous solution (pH adjusted to 8) of iso-ascorbic acid (22.2 g).

The batch was filtered through a filter cloth to remove any coagulum formed during the reaction. The solids content of the resultant aqueous binder dispersion was 35%. The overall polyurethane/vinyl polymer ratio of Example 1 was 80/20 wt % and the vinyl polymer had a calculated Tg of −10° C.

### EXAMPLE 2

### (E2) Preparation of a Polyurethane Vinyl Hybrid

Example E2 was prepared as example E1 above, except that the vinyl polymer had a calculated Tg of −30° C. by varying the weight fractions of the comonomers in accordance with the Fox equation.

### EXAMPLE 3

### (E3) Preparation of a Polyurethane Vinyl Hybrid

Example E3 was prepared as example E1 above, except that the vinyl polymer had a calculated Tg of −50° C. by varying the weight fractions of the comonomers in accordance with the Fox equation.

### COMPARATIVE EXAMPLE 1

### (CE1) Preparation of a Polyurethane Vinyl Hybrid

Comparative example CE1 was prepared as example E1 above, except that the vinyl polymer had a calculated Tg of 105° C. by varying the weight fractions of the comonomers in accordance with the Fox equation.

### COMPARATIVE EXAMPLE 2

### (CE2)Preparation of a Polyurethane Vinyl Hybrid (NCO/OH Ratio>1.75)

A 2000 cm³ flask equipped with a thermometer and overhead stirrer was charged with DMPA (44.0 g), Priplast 3192 (565.0 g), MMA (220.0 g), IPDI (271.0 g) and lonol CP (0.33 g). The NCO/OH ratio was 2.0.

This mixture was heated to 50° C. and tin octoate (0.16 g) was added. The reaction was allowed to exotherm to 90° C. After the exotherm was complete the reaction was kept at 90° C. for 1 hour and another portion of tin octoate (0.16 g) was added. After that, the reaction temperature was maintained at 90° C. for an additional 1 hour.

The NCO-content of the isocyanate-terminated pre-polymer was 4.38% (theoretical 4.66%). After cooling the pre-polymer to 75° C., TEA (29.9 g) was added.

A dispersion of the isocyanate-terminated pre-polymer was made by feeding 950.1 g of the TEA neutralised, isocyanate-terminated pre-polymer over 1 hour to 1615 g of deionised water. The isocyanate-terminated pre-polymer temperature during dispersion was kept at 70° C. and the dispersion temperature was controlled at 25° C. When the pre-polymer feed was completed, a 15.2% hydrazine solution (86.3 g) was added together with water (15.0 g) to effect chain-extension (0.85 SA on residual NCO content).

Fifteen minutes after completion of chain-extension, a 10% aqueous solution of tBHPO (9.26 g) was added together with a 1% aqueous solution of FeEDTA (0.92 g). The radical polymerisation for producing a polyurethane vinyl hybrid dispersion was executed by feeding a 2.5% aqueous solution (pH adjusted to 8) of iso-ascorbic acid (22.2 g).

The batch was filtered through a filter cloth to remove any coagulum formed during the reaction. The solids content of the resultant aqueous binder dispersion was 35%.

The overall polyurethane/vinyl polymer ratio of CE2 was 80/20 wt % and the vinyl polymer had a calculated Tg of 105° C.

### COMPARATIVE EXAMPLE 3

### (CE3) Preparation of a Polyurethane Vinyl Hybrid

Comparative example CE3 was prepared as comparative example CE2 above, except that the vinyl polymer had a calculated Tg of −50° C.

### COMPARATIVE EXAMPLE 4

### (CE4) Preparation of a Polyurethane Vinyl Hybrid (20/80)

A 1000 cm³ flask equipped with a thermometer and overhead stirrer was charged with DMPA (20.0 g), Priplast 3192 (283.2 g), MMA (33.5 g), BA (66.5 g), IPDI (96.8 g) and lonol CP (0.15 g) (an inhibitor to prevent premature polymerisation of the vinyl monomers). The NCO/OH ratio was 1.50.

This mixture was heated to 50° C. and tin octoate (0.08 g) was added. The reaction was allowed to exotherm to 90° C. After the exotherm was complete the reaction was kept at 90° C. for 1 hour and another portion of tin octoate (0.08 g) was added. After that, the reaction temperature was maintained at 90° C. for an additional 1 hour.

The NCO-content of the isocyanate-terminated pre-polymer was 2.23% (theoretical 2.44%). After cooling the pre-polymer to 75° C., TEA (13.6 g) was added.

A dispersion of the isocyanate-terminated pre-polymer was made by feeding 246.5 g of the TEA neutralised, isocyanate-terminated pre-polymer over 1 hour to 1636.2 g of deionised water. The isocyanate-terminated pre-polymer temperature during dispersion was kept at 70° C. and the dispersion temperature was controlled at 25° C. When the pre-polymer feed was completed, a 15.2% hydrazine solution (11.4 g) was added together with water (15.0 g) to effect chain-extension (0.85 SA on residual NCO content).

Fifteen minutes after completion of chain-extension, an extra addition of vinyl monomer was charged to the reactor. Monomer phase was MMA (112.7 g) and BA (223.3 g), the monomer phase was swollen for 30 minutes, and then a 10% aqueous solution of tBHPO (38.4 g) was added together with a 1% aqueous solution of FeEDTA (3.8 g). The radical polymerisation for producing a polyurethane vinyl hybrid dispersion was executed by feeding a 2.5% aqueous solution (pH adjusted to 8) of iso-ascorbic acid (46.1 g). Fifteen minutes after completion of iso-ascorbic acid the batch was cooled down to room temperature. At room temperature a second addition of monomer was charged to the reactor. Monomer phase was MMA (128.8 g) and BA (255.2 g), the monomer phase was swollen for 30 minutes. The radical polymerisation for producing a polyurethane vinyl hybrid dispersion was executed by feeding a 2.5% aqueous solution (pH adjusted to 8) of iso-ascorbic acid (46.1 g).

The batch was filtered through a filter cloth to remove any coagulum formed during the reaction. The solids content of the resultant aqueous binder dispersion was 35%.

The overall polyurethane/vinyl polymer ratio of CE4 was 20/80 wt % and the vinyl polymer had a calculated Tg of −10° C.

### Clear Formulation

To 100 gram of the aqueous binder dispersion prepared in the above examples, butyldiglycol (BDG, 2.5 g) and Dehydran 1293 (1.0 g) was added under stirring. The viscosity of the formulation was adjusted in the range from 500 to 2000 mPa·s with 50 wt % Borchigel L75.

### Pigmented Formulation

A pigment paste was prepared by mixing under high shear water (16.9 g), AMP-90 (0.6 g), Dehydran 1293 (1.4 g), Surfynol 104E (1.4 g), NeoCryl BT-24 (8.9 g) and Tioxide Kronos 2190 (70.8 g).

To 88 parts of the clear formulation prepared above, 30 parts of the pigment paste was added resulting in a pigment volume concentration PVC of approximately 20%.

### Determination of Tackiness

A 120 μm wet film of the clear formulation or pigmented formulation was cast on a glass plate and left to dry for 4 hours at ambient temperature. Then, a piece of cotton wool (about 1 cm³, 0.1 g) was placed on the dried film and a weight of 1 kg was placed on top of the cotton wool for 10 seconds. If the piece of cotton wool could be removed from the substrate by hand without leaving any wool or marks in or on the film, the film was considered to be tack-free. The results are shown in Table 1 below.

Determination of König Hardness

König hardness as used herein is a standard measure of hardness, being a determination of how the visco-elastic properties of a film formed from the composition slows down a swinging motion deforming the surface of the film, and is measured according to DIN 53157 using an Erichsen™ hardness equipment, wherein films were cast on glass plate at 80 micron wet film thickness at room temperature and allowed to stand for 30 minutes. The films were then transferred to an oven at 60° C. and left for 16 hours. The results are expressed as König seconds. The results are shown in Table 1 below.

### Determination of the Elongation at Break

400 μm wet films of the clear formulation or pigmented formulation were applied onto glass plates containing release paper. This film was allowed to dry for 4 hours under ambient conditions followed by ageing for 16 hours at 50° C. Next, the film was removed from the glass plate. From the free films at least 5 dumb bell shaped samples were cut using a DIN 52-910-53 cutter. The thickness of these films was measured. A stress-strain experiment was performed using an Instron™ 5565 instrument at a draw-bench speed of 100 mm/min. The results are shown in Table 2 below.

### Impact Resistance on Wood

A 250 μm wet film of the pigmented formulation was applied on wood and dried at room temperature for 4 hours followed by ageing at 50° C. for 16 hours. The test panels then were allowed to calibrate at 22° C. at 50% relative humidity for 6 hours. Next an impact test was done according to DIN 51155 (at room temperature, of 20+/−3° C.). Impact resistance may be used to show for example what the hail resistance would be. The results are shown in Table 2 below.

TABLE 1

| | | | Tg | PU/V^{b} | | Hardness |
|---|---|---|---|---|---|---|
| | | U/Ua | (vinyl) | ratio | | 20% PVC |
| | NCO/OH | Ratio^{a} | (° C.) | (wt %) | Tackiness | (s) |
| E1 | 1.5 | 2 | −10 | 80/20 | Tack-free | 29 |
| E2 | 1.5 | 2 | −30 | 80/20 | Tack-free | 28 |
| E3 | 1.5 | 2 | −50 | 80/20 | Tack-free | 25 |
| CE1 | 1.5 | 2 | 105 | 80/20 | Tack-free | 38 |
| CE2 | 2.0 | 1 | 105 | 80/20 | Tack-free | 60 |
| CE3 | 2.0 | 1 | −50 | 80/20 | Tack-free | 27 |
| CE4 | 1.5 | 2 | −10 | 20/80 | Tacky | 15 |

TABLE 2

| | Impact | Elongation | Elongation | Reduction in |
|---|---|---|---|---|
| | 20% PVC | at break | at break | elongation at break |
| | (N) | 20% PVC (%) | 0% PVC (%) | (%) |
| E1 | 50 | 308 | 418 | 26 |
| E2 | 80 | 396 | 453 | 13 |
| E3 | 40 | 457 | 602 | 24 |
| CE1 | 14 | 255 | 294 | 13 |
| CE2 | 8 | 124 | 199 | 38 |
| CE3 | 14 | 297 | 373 | 20 |
| CE4 | 18 | 526 | 565 | 7 |

^{a)} U/Ua ratio is the urethane/urea ratio
^{b)} PU/V is the polyurethane/vinyl polymer ratio in wt %.

Comparative example CE1 has a high Tg for the vinyl polymer (ii), which resulted in a low impact resistance for the pigmented coating.

Comparative example CE2 has an NCO/OH value>1.75 and the same (high) Tg for the vinyl polymer as in CE1 which resulted in a low impact resistance for the pigmented coating and a low elongation value for both the non-pigmented and the pigmented coatings.

Comparative example CE3 has an NCO/OH value>1.75, which resulted in a low impact resistance for the pigmented coating.

Comparative example CE4 has the reversed polyurethane/vinyl polymer ratio of 20/80 in wt %, which showed that an excess amount of the soft vinyl polymer resulted in a tacky coating having low impact resistance.

1. An aqueous coating composition comprising:
(i) 50 to 95 wt % of a polyurethane obtained by the reaction of:
(a) an isocyanate-terminated pre-polymer obtained from the reaction of components comprising:
(1) 10 to 40 wt % of at least one polyisocyanate of which at least 50 wt % is at least one aliphatic polyisocyanate;
(2) 0 to 10 wt % of at least one isocyanate-reactive compound with a weight average molecular weight in the range of from 50 to 500 g/mol, containing ionic or potentially ionic water-dispersing groups;
(3) 50 to 89 wt % of at least one isocyanate-reactive compound with a weight average molecular weight in the range of from 501 to 5000 g/mol;
(4) 0 to 10 wt % of at least one isocyanate-reactive compound with a weight average molecular weight in the range of from 50 to 500 g/mol not comprised by (2);
in an NCO/OH ratio in the range of from 1.75 to 1.05; and
where (1), (2), (3) and (4) add up to 100%; and
(b) an active-hydrogen chain-extending compound;
and
(ii) 5 to 50 wt % of a vinyl polymer having a Tg below ambient temperature;
wherein (i) and (ii) add up to 100%; and
(iii) a liquid medium comprising ≦10 wt % of organic solvent.

2. A composition according to claim 1 wherein the vinyl polymer has a weight average molecular weight of at least 200,000 g/mol.

3. A composition according to claim 1 wherein the vinyl polymer comprises≦8 wt % of monomers containing ionic or potentially ionic water-dispersing groups.

4. A composition according to claim 1 which further comprises pigment with a pigment volume concentration PVC in the range of from 10 to 70%.

5. A composition according to claim 1 with a pigment volume concentration PVC of 20+/−2%, which when coated into a film gives a tack-free film with an impact resistance of at least 30 N.

6. A composition according to claim 1 which when coated into a film gives a tack-free film with an elongation at break≧300%.

7. A composition according to claim 1 which, when coated into a pigmented film having a pigment volume concentration PVC of 20+/−2%, gives a tack-free film with a König hardness in the range of from 15 to 35 seconds.

8. A composition according to claim 1 comprising:
(i) 50 to 95 wt % of a polyurethane obtained by the reaction of:
(a) an isocyanate-terminated pre-polymer obtained from the reaction of components comprising:
(1) 10 to 40 wt % of at least one polyisocyanate of which at least 50 wt % is at least one aliphatic polyisocyanate;
(2) 0 to 10 wt % of at least one isocyanate-reactive compound with a weight average molecular weight in the range of from 50 to 500 g/mol, containing ionic or potentially ionic water-dispersing groups;
(3) 50 to 89 wt % of at least one isocyanate-reactive compound with a weight average molecular weight in the range of from 501 to 5000 g/mol;
(4) 0 to 10 wt % of at least one isocyanate-reactive compound with a weight average molecular weight in the range of from 50 to 500 g/mol not comprised by (2);
in an NCO/OH ratio in the range of from 1.75 to 1.05;
with a urethane/urea ratio>1; and
where (1), (2), (3) and (4) add up to 100%; and
(b) an active-hydrogen chain-extending compound;
and
(ii) 5 to 50 wt % of a vinyl polymer having a Tg below ambient temperature; a weight average molecular weight of at least 200,000 g/mol and comprising ≦8 wt % of monomers containing ionic or potentially ionic groups;
wherein (i) and (ii) add up to 100%; and
(iii) a liquid medium comprising ≦10 wt % of organic solvent; which composition further comprises pigment with a pigment volume concentration in the range of from 10 to 70%, and;
wherein the aqueous coating composition when comprising a pigment volume concentration PVC of 20±2% and coated into a film has a tack-free film of König hardness in the range of from 15 to 35 seconds; an impact resistance of at least 30 N; and an elongation at break≧300%.

9. A composition according to claim 1 wherein the aliphatic isocyanate is selected from the group consisting of isophorone diisocyanate, 4,4′-dicylohexylmethane diisocyanate, 1,6-hexamethylene diisocyanate and mixtures thereof.

10. A composition according to claim 1 wherein the total amount of active hydrogen chain-extender is such that the ratio of active hydrogens in the chain-extender to isocyanate groups in the pre-polymer is within the range of from 0.4 to 2.0.

11. A composition according to claim 1 wherein the polyurethane has urethane linkages and urea linkages and wherein the polyurethane and vinyl polymer are present as part of a hybrid.

12. A composition according to claim 1 wherein the urethane/urea ratio is >1.

13. A composition according to claim 1 which is substantially solvent free.

14. A composition according to claim 1 with a pigment volume concentration of 20±2% which when coated into a film gives a tack-free film which has a reduction in elongation at break less than 30% when compared with an equivalent non-pigmented film.

15. A composition which, when coated into a pigmented film having a pigment volume concentration PVC of 20+/−2%, gives a tack-free film with a König hardness in the range of from 15 to 35 seconds, an elongation at break≧300% and an impact resistance of at least 30 N.

16. A composition according to claim 15 which has a reduction in elongation at break less than 30% when compared with an equivalent non-pigmented film.

17. A coating obtained from a composition according to claim 1.

18. A method of coating a surface of a substrate with a composition according to claim 1 comprising the steps of applying the composition to the surface and then drying the composition.

19. A method according to claim 18 wherein the substrate is selected from the group consisting of wood, plastic, metal and paper.

20. A film obtained from a composition according to claim 1.
